(19) United States
(12) Patent Application Publication
(10) Pub. No.: US 2021/0010305 A1
(43) Pub. Date: Jan. 14, 2021

(54) PIPE FENCE GATE STABILIZER

(71) Applicant: Thomas Olsen, Pauls Valley, OK (US)

(72) Inventor: Thomas Olsen, Pauls Valley, OK (US)

(21) Appl. No.: 16/510,961

(22) Filed: Jul. 14, 2019

(51) Int. Cl. E05C 17/54

(52) U.S. Cl. CPC E05C 17/54

(57) ABSTRACT

An illustrated view of an exemplary pipe gate for securely and safely keeping a gate of a fence in an open position. The pipe gate is useful for safely and easily keeping the gate of the fence in the open position. Instead of using bricks, sticks, stumps or tying the gate back, each of these are commonly used currently, the gate of the fence can be opened to any size opening and with the placement of the pipe gate, the gate remains open without creating a safety hazard for those in the general area. The pipe gate has a first portion that is configured to receive a rod and then securely coupling the rod at a desired length by inserting and securely coupling a bolt thru a hole in the first portion. The first portion has a hook end to hook onto a rail of a gate and may have a coupling device such as a clamp to secure the pipe gate to the gate. The end of the rod is preferably pointed and is securely coupled to the ground.

### FIELD OF THE INVENTION

This invention relates to fencing. More particularly, it relates to device to keep a gate of a fence open.

### BACKGROUND

A fence is a structure that encloses an area, typically outdoors, and is usually constructed from posts that are connected by boards, wire, rails or netting. A fence differs from a wall in not having a solid foundation along its whole length.

Alternatives to fencing include a ditch (sometimes filled with water, forming a moat).

A gate or gateway is a point of entry to a space which is enclosed by walls or fencing. Gates may prevent or control the entry or exit of individuals, livestock, or they may be merely decorative. Other terms for gate include yett and port. The word is derived from old Norse “gat”, meaning road or path, and originally referred to the gap in the wall or fence, rather than the barrier which closed it. The moving part or parts of a gateway may be considered “doors”, as they are fixed at one side whilst opening and dosing like one.

A gate may have a latch that can be raised and lowered to both open a gate or prevent it from swinging. Locks are also used on gates to increase the security. Larger gates can be used for a whole building, such as a castle or fortified town. Actual doors can also be considered gates when they are used to block entry as prevalent within a gatehouse. Today, many gate doors are opened by an automated gate operator.

A problem may occur when a gate is open in a fence on a farm or outdoors. The gate is subject to the winds, curvature and lay of the land and becoming unbalanced over time. In these cases, the gate may become unstable or unbalanced and when in an open position be closed by the conditions noted above. In light of the problems described above and other problems, a device is needed to keep the gate in an open position and prevent the gate from closing when not desired.

### BRIEF DESCRIPTION OF THE DRAWINGS

FIG. 1 is an illustrated view of an exemplary pipe gate.

FIG. 2 is an illustrated view of a fence gate with the exemplary pipe gate shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

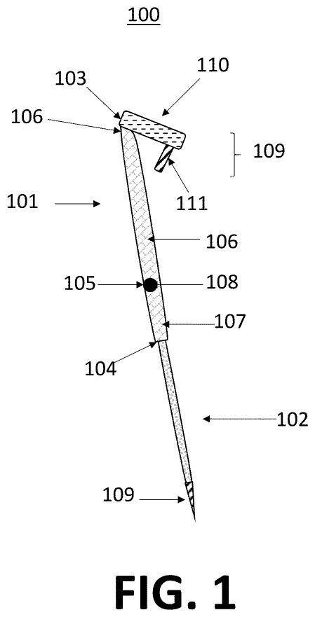

Referring to FIG. 1, an illustrated view of an exemplary pipe gate 100 for securely and safely keeping a gate of a fence in an open position. The pipe gate 100 is useful for safely and easily keeping the gate of the fence in the open position. Instead of using bricks, sticks, stumps or tying the gate back, each of these are commonly used currently, the gate of the fence can be opened to any size opening and with the placement of the pipe gate 100, the gate remains open without creating a safety hazard for those in the general area.

The pipe gate 100 is preferably two (2) feet in length, but other lengths are hereby contemplated including, but not limited to, one and one-half (1.5) feet, three (3) feet, etc. The pipe gate 100 is preferably one (1) inch in width, but other widths are hereby contemplated including, but not limited to, one-half (0.5) inch, two (2) inches, etc. The pipe gate 100 is preferably adjustable in length.

The pipe gate 100 has a first portion 101 and a rod 102. The first portion 101 is preferably made of a one-half (0.5) inch poly-vinyl chloride (PVC) material often found in conduits but other materials are hereby contemplated including, but not limited to, aluminum, high-density poly-ethylene (HDPE), low-density poly-ethylene (LDPE), plastic, etc. The first portion 101 of the pipe gate 100 is preferably cylindrical in shape, but other shapes are hereby contemplated including, but not limited to, rectangular, etc. The first portion 101 of the pipe gate 100 is preferably five (5) inches in length, but other lengths are hereby contemplated including, but not limited to, four (4) inches, six (6) inches, etc. The first portion 101 of the pipe gate 100 is preferably adjustable in length.

The first portion 101 of the pipe gate 100 has a hook 103, an opening 104 and a hole 105. The hook 103 being on the top end 106 of the first portion 101 of the pipe gate 100 to allow the pipe gate 100 to be securely coupled to a rail of the gate.

The hole 105 is configured to be between a center portion 106 and a second end 107 of the first portion 101 of the pipe gate 100. The hole 105 is configured with a secure coupling 108 to securely couple the rod 102 at a desired length. The secure coupler 108 is preferably a one-quarter (0.25) inch bolt, but other couplers are hereby contemplated including, but not limited to, a screw, a dowel rod, etc.

Optionally and/or additionally, the hook 103 of the first portion 101 of the pipe gate 100 may have a coupler 109. The coupler 109 may be useful for securely coupling the pipe gate 100 to the rail of the gate of the fence. The coupler 109 has a first portion 110 and a coupling device 111. The first portion 110 of the coupler 109 is configured to receive the coupling device 111. The coupling device 111 is preferably a one-quarter (0.25) inch bolt, but other couplers are hereby contemplated including, but not limited to, a screw, a dowel rod, etc. preferably a one-quarter (0.25) inch bolt, but other couplers are hereby contemplated including, but not limited to, a screw, a dowel rod, etc.

The opening 104 is configured at the second end 107 of the first portion 101 of the pipe gate 100. The opening 104 is configured to receive the rod 102 of the pipe gate 100. The length of the rod 102 of the pipe gate 100 may be adjusted to a desired length by lengthening or shortening the length of the rod 102 configured to be inside of the first portion 101 of the pipe gate 100. The rod 102 is preferably made of a three-eighths (⅜) inch rebar material, but other materials are hereby contemplated including, but not limited to, steel, aluminum, titanium, PVC, etc.

The rod 102 has a second end 109, the second end 109 of the rod 102 is preferably a point, but other types of ends are hereby contemplated including but not limited to, flat, angled, etc. The second end 109 is configured to be securely coupled to a land.

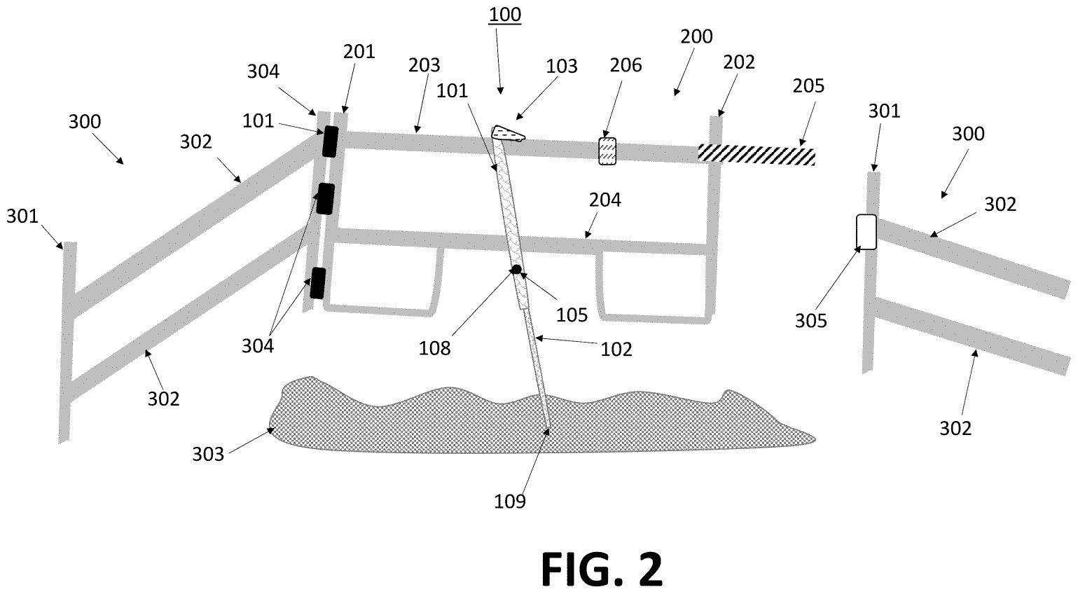

Moving now to FIG. 2, an illustrated view of a gate 200 of a fence 300 is configured to an open position by the exemplary pipe gate 100 shown in FIG. 1.

The fence 300 has a plurality of posts 301 and a plurality of rails 302. The plurality of rails 302 of the fence 300 are securely coupled to the plurality of posts 301 of the fence 300. The plurality of rails 302 coupled to the plurality of posts 301 are configured to define and provide secured access to a land 303. At least one of the posts 301 has a plurality of hinges 304. The plurality of hinges being hingedly coupled to the gate 200.

The gate 200 has a first post 201 and a second post 202, wherein the gate 200 is configured to a length defined by a distance between the first post 201 of the gate 200 and the second post 202 of the gate 200.

The gate 200 has a plurality of rails 203, 204. The plurality of rails 203, 204 of the gate 200 are securely coupled to the first post 201 and the second post 202 of the gate 200. The hinges 304 are coupled to the first post 201 of the gate 200, thus hingedly coupled to the post 301 of the fence 300. Thus, the gate 200 is adjustable for opening and closing without being removable from the fence 300.

The gate 200 further has a latch bar 205. The latch bar 205 of the second post 202 of the gate 200. When the gate 200 is closed, the latch bar 205 is removably and securely coupled to a latch 305 of the fence 300.

To secure the opening of the gate 200 position, after assembling the pipe gate 100, the hook 105 of the pipe gate 100 is configured to be securely and removably coupled to the rail 203 of the gate 200. If the secure coupler 108 is configured, then the secure coupler 108 is securely coupled to a back (not shown) of the rail 203 of the gate 200.

The second end 109 of the rod 102 of the pipe gate 100 is securely coupled to the land 303. Thus, the gate 200 remains in an open position until it is desired to close the gate 200.

Once the rod 102 has been configured to be the desired length, the secure coupler 108 is configured to be inserted into the hole of the first portion 101 of the pipe gate 100 and be in physical contact with the rod 102 of the pipe gate 100 thus securing the rod 102.

Optionally and/or additionally, the gate 200 may have a storage coupler 206. The storage coupler 206 is securely coupled to the rail 203 of the gate 200. The storage coupler 206 may be securely coupled to the rail 203 of the gate by a one-quarter (0.25) inch bolt or other type of coupling device such as a screw, dowel rod, etc. The pipe gate 100 may be stored by removably coupling the second end 109 of the rod 102 of the pipe gate 100 to the storage coupler 206 of the gate 200.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pipe gate for securing a gate in an open position, the pipe gate comprising:
a first portion, the first portion being hollow;
a rod, the rod being inserted to a desired length in the first portion;
a hole in the first portion, wherein a coupling device is inserted into the hole and securely couple the rod at the desired length;
a hook on a top end of the first portion, wherein the hook being securely coupled to a rail of a gate; and
a second end of the rod, wherein the second end of the rod being securely coupled to a land.

2. The pipe gate of claim 1, wherein the pipe gate further comprising:
a coupler coupled to the hook of the first portion of the pipe gate; and
wherein the coupler being securely and removably coupled to the gate by a coupling device.

3. The pipe gate of claim 2, wherein the coupling device being a one-quarter (0.25) inch bolt.

4. The pipe gate of claim 1, wherein the pipe gate having a length of two (2) feet.

5. The pipe gate of claim 1, wherein the pipe gate having a width of one (2) inch.

6. The pipe gate of claim 1, wherein the second end of the rod being a point.

7. The pipe gate of claim 1, wherein the first portion of the pipe gate being made of a poly-vinyl chloride (PVC) material.

8. The pipe gate of claim 1, wherein the rod being made of a three-eighths (⅜) inch rebar material.

9. The pipe gate of claim 1, wherein the first portion of the pipe gate having a length being five (5) inches.

10. The pipe gate of claim 1, wherein the pipe gate being adjustable in length.

11. The pipe gate of claim 1, wherein the pipe gate further comprising:
a storage coupler;
the storage coupler being securely coupled to the rail of the gate; and
Wherein the pipe gate being securely and removably coupled to the storage coupler when the gate is in a closed position.
